(19) United States
(12) Patent Application Publication
(10) Pub. No.: US 2008/0049692 A1
(43) Pub. Date: Feb. 28, 2008

(54) Apparatus and Method For Resource Allocation and Data Transmission Using Heterogeneous Modulation Formats in a Wireless Packet Communication System

(75) Inventors: Raja S. Bachu, Des Plaines, IL (US); Michael E. Buckley, Grayslake, IL (US); Ravi Kuchibhotla, Gurnee, IL (US); Robert T. Love, Barrington, IL (US); Kenneth A. Stewart, Grayslake, IL (US); Jianzhong Zhang, Irving, TX (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Libertyville, IL (US)

(21) Appl. No.: 11/466,760

(22) Filed: Aug. 23, 2006

(51) Int. Cl. H04Q 7/24

(52) U.S. Cl. 370/338

(57) ABSTRACT

A base station (103) assigns a set of mobile stations (101) to a group wherein the group will share a set of radio resources (770). A control field (1103) may be sent with a payload field (1105) wherein the control field (1103) and payload field (1105) are sent using a single Orthogonal Variable Spreading Factor or a single Walsh Code (1101) wherein various modulation and coding schemes may be applied to the control field (1103) and payload field (1105) such that different modulation and coding schemes may be used within the single channel. HARQ is handled by sending a single retransmission if a NACK message is received or no ACK/NACK message is received at all.

### CROSS-REFERENCE TO RELATED APPLICATIONS

The present disclosure is related to copending U.S. patent application Ser. No. 11/460,908 “APPARATUS AND METHOD FOR HANDLING CONTROL CHANNEL RECEPTION/DECODING FAILURE IN A WIRELESS VOIP COMMUNICATION SYSTEM,” and U.S. patent application Ser. No. 11/464,179 “APPARATUS AND METHOD FOR AUTOMATIC REPEAT REQUEST WITH REDUCED RESOURCE ALLOCATION OVERHEAD IN A WIRELESS VOIP COMMUNICATION SYSTEM,” both of which are assigned to the same assignee as the present application, and both of which are hereby incorporated by reference herein.

### FIELD OF THE DISCLOSURE

The present disclosure relates generally to packet data wireless communication networks having applications including, but not limited to, Voice-over-Internet-Protocol (VOIP) and gaming, and more particularly to such networks utilizing hybrid automatic repeat request (HARQ) and methods and apparatuses with reduced signaling overhead in wireless communications systems utilizing HARQ mechanisms.

### BACKGROUND

Wireless communications systems, for example packet based communications systems, may provide for various applications having small or otherwise determinable packet sizes such as, but not limited to, voice telephony using the Voice-over-Internet-Protocol (VoIP), gaming, etc. Any historical demarcation between “data” and “voice” has become blurred in packet based communications systems such that the term “data” usually signifies payload information for any service, whether voice, or data such as may be provided by downloading from the Internet.

Differences remain however, in that voice will generally employ smaller packet sizes, for example due to delay sensitivity, than would traditional so-called data. For, example a non-voice data packet may be larger than a kilo-byte while a voice packet may be only approximately 15 to 50 bytes depending upon the vocoder rate employed.

Because of the smaller packet sizes utilized by voice sessions, a greatly increased number of voice users may be served thereby placing a burden on the control mechanisms and resources of the communications system. Further for Voice-Over-IP (VOIP) communications, RTP/UDP/IP (Real-Time Transport protocol/User Datagram Protocol/Internet protocol) overhead is added to each vocoder packet, in addition to Cyclic Redundancy Check (CRC) bits, etc. which increases delay and overhead.

Systems that employ Hybrid Automatic Repeat Request (HARQ) are further burdened by such protocol overhead in addition to control requirements. Further, the delay inherent in HARQ due to acknowledgment messaging, resource reallocations and retransmissions may be unacceptable for voice applications.

Another consideration is transmission interval times defined for packet based communication systems generally which may be too large for the small packet sizes used for real time voice, such as VoIP, applications. In this case, the issue of frame fill efficiency limits the achievable user capacity of the packet based communications system.

Thus, there is a need for providing mobile stations with resources for voice data and control information and HARQ retransmission opportunities without significantly increasing the overhead and/or inherent delay of the communication system.

### BRIEF DESCRIPTION OF THE DRAWINGS

FIG. 1 is a block diagram of a wireless communication network.

FIG. 2 is block diagram of a sequence of super frames each comprising a several frames.

FIG. 3 is diagram showing a sequence of long frames each comprising one or more frames.

FIG. 4 is logical diagram representation of a set of shared resources.

FIGS. 5a and 5b are diagrams of bitmaps sent in a shared control channel for resource assignment purposes.

FIG. 6 illustrates a resource allocation table, where the resource allocation table indicates the number of blocks allocated for each HARQ transmission opportunity, in accordance with some embodiments.

FIG. 7 is a diagram showing an exemplary resource allocation and ordering pattern for a group of mobile stations.

FIG. 8 is a diagram showing the exemplary resource allocation and ordering pattern of FIG. 7 at a subsequent long frame.

FIG. 9 illustrates the association of a sequence of HARQ transmission opportunities with long frame numbers for different subgroups in accordance with various embodiments.

FIG. 10 is a diagram with exemplary grouping and periodic resource allocation in accordance with various embodiments.

FIG. 11 is a diagram showing a single resource, such as a Walsh Code, having a control field and a payload field in accordance with various embodiments.

FIG. 12 is a table providing exemplary information contained in the control field of the resource illustrated by FIG. 11, in accordance with various embodiments.

FIG. 13 is a block diagram illustrating decoding and mapping of control bits to QPSK or 16-QAM symbols in accordance with various embodiments.

FIG. 14 is an architecture diagram of a mobile station and a base station in accordance with an embodiment.

FIG. 15 is a block diagram showing components of a mobile station in accordance with an embodiment.

FIG. 16 is a flow chart showing operation of a base station in accordance with various embodiments.

FIG. 17 is a flow chart showing operation of a mobile station in accordance with various embodiments.

FIG. 18 is a flow chart of CRC bit sequence generation for a payload field in accordance with an embodiment.

### DETAILED DESCRIPTION

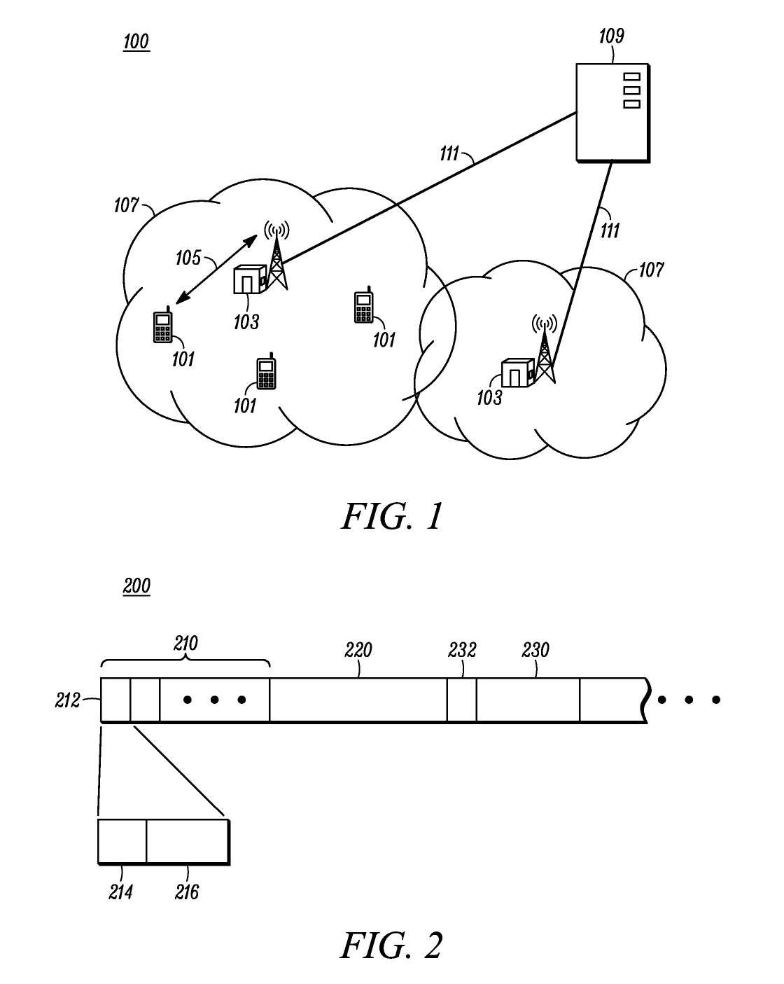

Turning now to the drawings wherein like numerals represent like components, FIG. 1 illustrates a communications network 100, with various base stations 103, each base station 103 having a corresponding coverage area 107. In general, base station coverage areas may overlap and, in general, form an overall network coverage area. The base stations may be referred to by other names such as base transceiver station (BASE STATION), “Node B”, and access node (AN), depending on the technology. A network coverage area may comprise a number of base station coverage areas 107, which may form a contiguous radio coverage area. However, it is not required to have contiguous radio coverage and therefore a network coverage area may alternatively be distributed.

Furthermore, each coverage area may have a number of mobile stations 101. A number of bases stations 103 will be connected to a base station controller 109 via backhaul connections 111. The base station controller 109 and base stations form a Radio Access Network (RAN). The overall network may comprise any number of base station controllers, each controlling a number of base stations. Note that the base station controller 109 may alternatively be implemented as a distributed function among the base stations 103. Regardless of specific implementations, the base station controller 109 comprises various modules for packetized communications such as a packet scheduler, packet segmentation and reassembly, etc., and modules for assigning appropriate radio resources to the various mobile stations 101.

The base stations 103 may communicate with the mobile stations 101 via any number of standard air interfaces and using any number of modulation and coding schemes. For example, Universal Mobile Telecommunications System (UMTS), Evolved UMTS (E-UMTS) Terrestrial Radio Access (E-UTRA) or CDMA2000 may be employed. Further, E-UMTS may employ Orthogonal Frequency Division Multiplexing (OFDM) and CDMA2000 may employ orthogonal spreading codes such as the Walsh codes. Semi-orthogonal spreading codes may also be utilized to achieve additional channelization over the air interface. Further the network may be an Evolved High Rate Packet Data (E-HRPD) network. Any appropriate radio interface may be employed by the various embodiments.

FIG. 2 illustrates a sequence of super frames 200 useful for communicating in the wireless communication systems of the various embodiments. In FIG. 2, the super frame sequence generally comprises a number of super frames 210, 220, 230, etc., wherein each super frame comprises a number of frames. For example, super frame 210 comprises a frame 212 having a resource assignment control channel portion within a control channel portion 214 and a data channel portion 216.

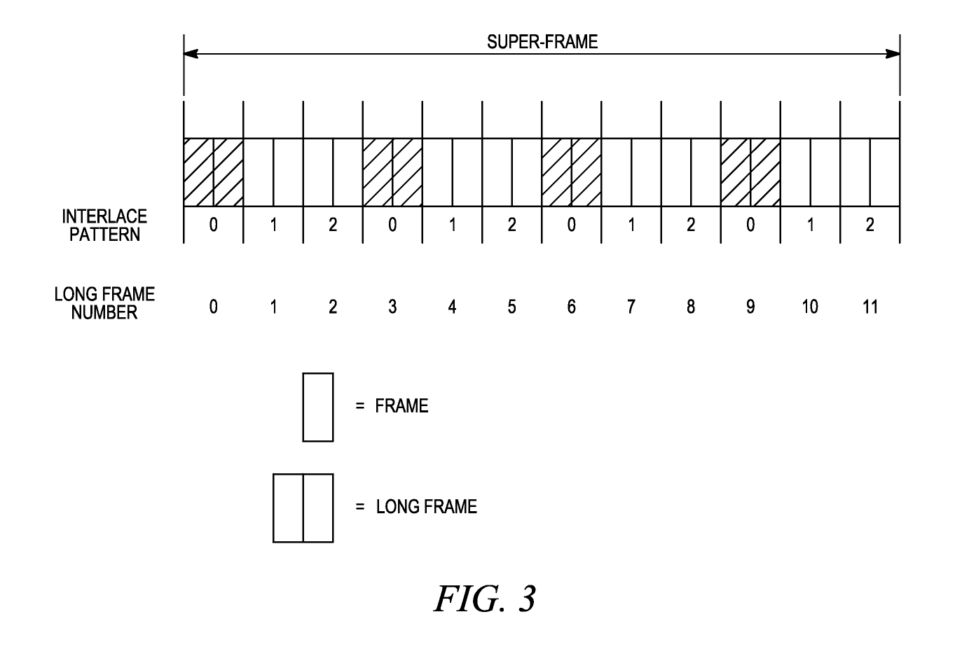

FIG. 3 illustrates a sequence of repeating long frames, wherein two frames are grouped to form a long frame. In some embodiments, a long frame is equivalent to a single frame. An interlace pattern is defined as a sequence of regularly distanced long frames. For systems employing synchronous hybrid automatic repeat request (HARQ) (S-HARQ), the initial and subsequent transmissions typically occur in the same interlace pattern. In this illustrative example, 12 long frames, denoted long frame 0 through 11, make up a super-frame.

For orthogonal frequency division multiple access (OFDMA) systems, the frequency domain is divided into subcarriers. For example, a 5 MHz OFDMA carrier, may be divided into 480 subcarriers, with a subcarrier spacing of 9.6 kHz. An OFDMA frame may be divided into multiple OFDM symbols. For example, a frame may occupy 0.91144 msec and contain 8 OFDM symbols, where each symbol occupies approximately 113.93 μsec. The subcarriers are grouped to form block resource channels (BRCH) and distributed resource channels (DRCH). A BRCH is a group of contiguous subcarriers that may hop within a larger bandwidth, while a DRCH is a group of noncontiguous sub-carriers.

In the various embodiments, the base station controller 109, the base stations 103, or some other network infrastructure component groups mobile stations 101 into one or more groups for scheduling purposes. The mobile stations 101 may be grouped based on radio channel conditions associated with the mobile stations, for example, channel quality information reported by the mobile stations, Doppler reported by the mobile stations, distance from the serving cell, etc.. Alternatively, or additionally, the mobile stations 101 may be grouped based on one or more mobile station operating characteristics other than participation in a common communication session. Exemplary mobile station operating characteristics include power headroom of the mobile stations, macro diversity considerations, mobile station capability, service of the mobile station, codec rate, etc.. Further, mobile stations with an active VoIP session may be grouped together.

In another embodiment, the base station controller 109, the base stations 103, or some other network infrastructure component may assign multiple mobile stations to the same group position. For example, all mobile stations participating in the same group call may be assigned to the same group position. Similarly, all mobile stations registered for a particular broadcast/multicast session may be assigned to the same group position. In this way, the base station indicates the presence or absence of a group call or a broadcast/multicast session to several mobile stations using a single bit in the shared control channel, thereby reducing group overhead. In this embodiment, a mobile station may be assigned more than one group position within the same group. For example, the base station may assign a mobile station one group position for broadcast/multicast and another group position for VoIP.

After the group of mobile stations has been determined, the base station 103 sends an indication to the mobile stations 101 of each mobile station's position in the group and an indication of the group identifier. A control channel may be used to send the indications. The base station 103 may use the group identifier to send control information valid for the entire group. For example, the base station 103 may change the frequency allocation for the group by sending an indication of the group identifier and an indication of the new frequency allocation. The position indications may be sent to each mobile station separately or may be sent to several mobile stations at once.

For example, the base station 103 may send a list of wireless mobile station unique identifiers along with a group identifier. Any appropriate rule may be used to determine the position indication, for example, the first mobile station in the list of unique identifiers may be assigned the first position, the second mobile station in the list of unique identifiers may assigned the second position, etc. The mobile station unique identifier may be an Electronic Serial Number (ESN), a subscriber hardware identifier, a Medium Access Control Identifier (MAC-Id), or any other suitable identifier that uniquely identifies a particular mobile station.

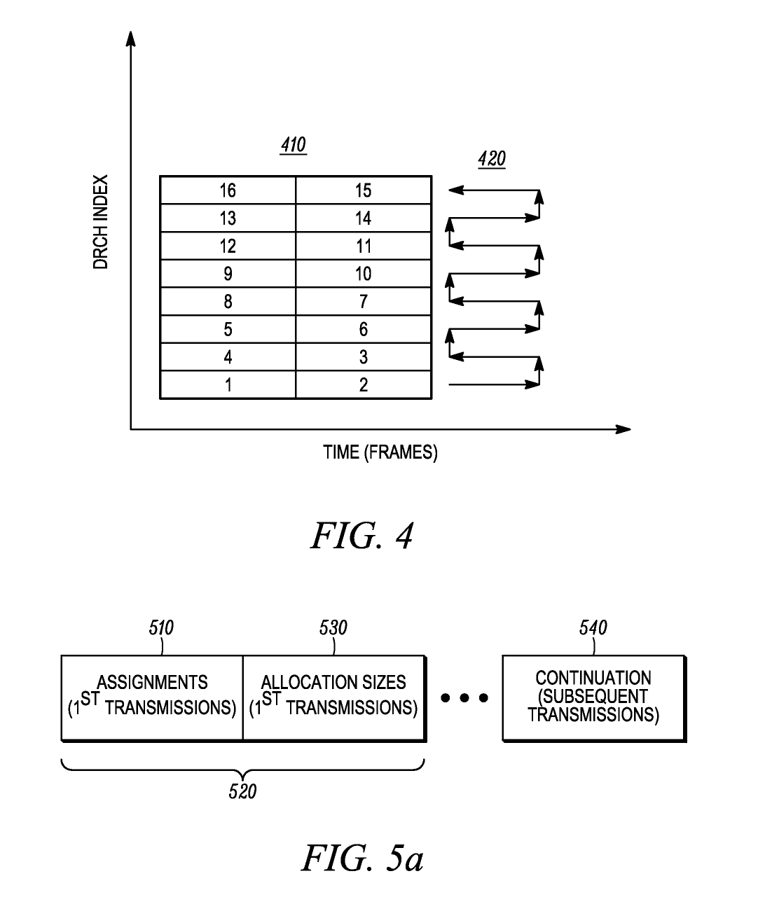

For each mobile station group, a scheduling function of the base station controller 109, or base station 103, may assign a set of time-frequency resources to be shared by the mobile stations in the group. FIG. 4 shows an exemplary set of shared resources. In FIG. 4, the shared resources 410 are two frames (one long frame) and eight DRCHs. If a block is defined as one frame in the time domain and one DRCH in the frequency domain, then there are 16 blocks or resources, numbered 1 through 16. As previously discussed, a DRCHs is a group of non-contiguous subcarriers, so the DRCH Index which is the vertical axis of FIG. 4, is a logical representation of the frequency domain. As will be discussed later, each mobile station determines its portion of the shared resource, based on the assignments for other mobile stations. Therefore, it is necessary to define the order in which the resources are to be allocated. In FIG. 4, an illustrative ordering pattern 420 is given which results in the blocks being numbered 1 through 16 as shown in FIG. 4. The set of shared resources may be repeatedly used in an interlace pattern as described with respect to FIG. 3. For example, the 16 resources may be repeatedly used in each long frame of interlace pattern 0 in FIG. 3. Again, the 16 resources illustrated by FIG. 4 are logical representations of a set of sub-carriers in the frequency domain in a frame. It is to be understood that the exact physical location of these sub-carriers may change from frame to frame.

An indication of the set of shared resources and the ordering pattern may be signaled from the base station 103 to the mobile stations 101 using a control channel. Further, the control channel may be transmitted in any frame with a pre-defined relationship with the beginning frame of the set of shared resources. The set of shared resources may begin in the same frame the control channel is transmitted, may have a fixed starting point relative to the frame that the control channel is transmitted, or may be explicitly signaled in the control channel.

After the mobile stations are grouped, assigned a position (also called location) within the group, and a set of shared resources is assigned to the group, the base station 103 must indicate which mobile stations are active in a given time period, and, in some embodiments, the number of assigned resources assigned to each mobile station.

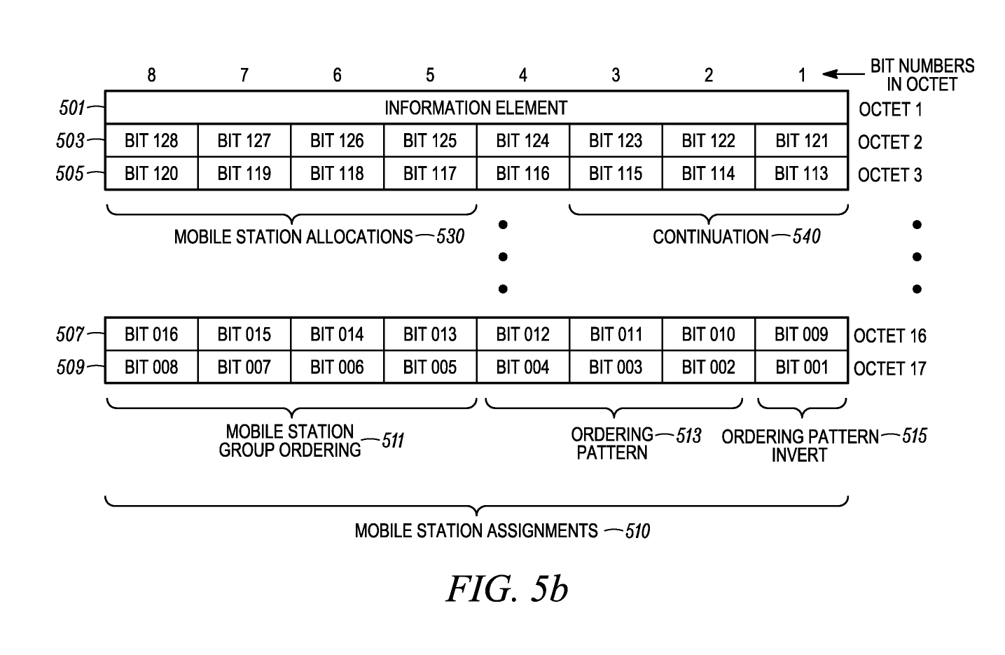

FIG. 5a illustrates how resource assignments may be indicated to mobile stations 101. In FIG. 5, a first message field, mobile station assignments 510, indicates which mobile stations are assigned at least one of the shared resources in the corresponding set of group shared resources. A mobile station resource allocation field 530 may indicate specific resources, and/or the number of resources assigned to each mobile station. In the various embodiments, a continuation field 540 may also be included as will be described further below.

FIG. 5b show an example with further details of how the message of FIG. 5a may convey information using bit mapping. FIG. 5b represents an information element 501 which as discussed above, may be sent to the mobile station over a control channel. In the case of a mobile station group as discussed above, the information element 501 may be sent using a shared control channel. The information element 501 may comprise a number of octets as shown, and may vary in size depending on, for example, the number of mobile stations in a group, sharing the control channel. Therefore, the information element 501 may be any appropriate size for conveying the necessary information to the mobile station group.

Thus, the mobile station assignments 510 may comprise a number of bitmap fields, for example Bits 001 through bit 008 of octet 17, item 509, as shown in FIG. 5b. In the example illustrated, the position of any mobile station within its group may corresponds to its bitmap position. For example, the mobile station assigned the first group position, “position 1” may determine if it is assigned one of the shared resources using bitmap position 001. In the example illustrated by FIG. 5b, the mobile station positions are indicted by mobile station group ordering field 511. Thus, the first mobile station position in the example of FIG. 5b would correspond to Bit 005, which is the first position of the mobile station group ordering field 511. The mobile station assigned group position 2 may determine if it is assigned one of the shared resources using second position of the mobile station group ordering field 511, etc. Further, an active user indication may be provided by using either a binary “0” or a “1”, where inactive users are indicated using the opposite state, or some other appropriate binary values may be used.

It is to be understood that a bitmap field may comprise one or more bits, and that a group of bits may be used for any designation or indication. Thus, the mobile station assignments 510 and sizes field 530 may provide two bits per mobile station, wherein binary “00” indicates no transmission, and “01,” “10” and “11” indicate transmissions occupying various numbers of blocks. For example, “011” may correspond to a single block, “10” may correspond to two blocks, and “11” may correspond to three blocks. It is also to be understood that a nonlinear mapping may also be used. For example, “01” may correspond to a single block, “10” may correspond to two blocks, and “11” may correspond to four blocks. For simplification of explanation henceforth, the assignments field 510 and the allocations sizes field 530 may be referred to herein together as “assignments and sizes” field 520 with the understanding of the various structures such fields may have as was discussed above.

Returning to FIG. 5b, active mobile stations may be indicated using a binary “1” in an appropriate corresponding position of the assignment bitmap 510 which is contained in the information element 501. Some embodiments, may include a single bit located at the logical beginning, or any other appropriate location or field, of the assignment bitmap 510, denoted the “ordering pattern invert field” 515. For example, the binary value of a bit, such as Bit 001, may indicate whether to follow a specifically designated ordering pattern in ascending or descending order. Thus, a binary ‘0’ may indicate that the mobile stations should use a first designated ordering pattern in ascending order (not inverted), while a binary ‘1’ may indicate that the ordering pattern should be inverted, that is, in descending order.

In other embodiments, several ordering patterns may be established, and the base station 103 may indicate the ordering pattern to be used by the mobile station 101 group via ordering pattern field 513 of the assignment bitmap 510. Therefore the base station 103 may indicate the desired ordering pattern during each scheduling instance. Further, the ordering pattern may be established at call setup and not signaled as part of the mobile station assignments 510.

Thus, in FIG. 5b, Bit 002, 003 and 004 may form the ordering pattern field 513 for designating the appropriate ordering pattern, and Bit 001 may form an ordering patter invert field 515 for indicating whether the ordering pattern is in ascending or descending order.

In FIGS. 5a and 5b, the allocation sizes field 530 indicates radio resource assignment weighting information, and may also indicate a proportion of radio resources assigned, to the mobile stations. The radio resource assignment weighting information may also indicate a specified number or size of radio resources assigned to each mobile station.

In some embodiments, the radio resource assignment weighting information may also include vocoder rate, modulation, or coding information. If there is only one possible weighting value, the allocation sizes field 530 may be omitted. The information element 501 which contains the mobile station assignments field 510 and, if used, the allocation sizes field 530 as discussed above, are sent to the mobile station group over the shared control channel. Also as discussed above the mobile station group also shares a set of time-frequency resources. The shared control channel is typically transmitted by the base station 103 in each long frame for assigning resources within the long frame, although it is understood that the shared control channel could be transmitted by the base station 103 in any preceding long frame. In the various embodiments, the information element 501 may also include a continuation field 540 which may comprise any appropriate number of bits and which will be described in further detail below.

In some embodiments wherein hybrid automatic repeat request (HARQ) is utilized, resources are allocated, that is, the size of the allocation (the number of blocks) is only indicated, for the first transmission in a series of HARQ transmission opportunities. In such embodiments, a continuation is indicated, via continuation field 540, for the subsequent transmission opportunities. Further in such embodiments, the continuation indication may be provided by a single bit.

In the various embodiments, the mobile station assignments and sizes field 520 is utilized by each mobile station in the current frame for which a first HARQ transmission opportunity is defined, and the continuation field 540 is utilized by each mobile station in the current frame for which a subsequent, that is, a second, third, or fourth HARQ transmission opportunity is defined. The mobile station assignments and sizes field 520 may indicate the number of blocks allocated for the first transmission. For this case, the continuation field may indicate that the same number of blocks allocated by the mobile station assignments and sizes field 520 are allocated for the subsequent transmissions or may indicate that a different number of blocks, for example a single block, is allocated for the subsequent transmissions.

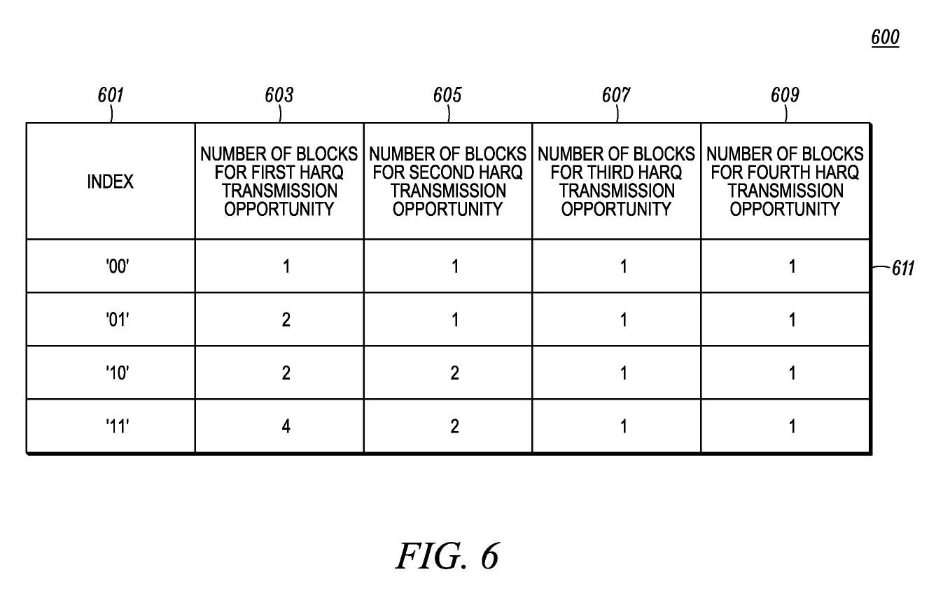

In some embodiments, the mobile station assignments and sizes field 520 is an index to a resource allocation table, where the resource allocation table indicates the number of blocks allocated for each HARQ transmission opportunity. FIG. 6 provides an example of such a table in accordance with the various embodiments. As illustrated by FIG. 6, the mobile station assignments and sizes field 520 may provide two binary bits per mobile station in which the two binary bits index a resource allocation table 600.

For example, referring to FIG. 6, row 611, if a mobile station assignments and sizes field 520 indicates binary ‘00’ for a particular mobile station, then the mobile station will be allocated one block for the first HARQ transmission opportunity per column 603, one block for the second HARQ transmission opportunity per column 605, one block for the third HARQ transmission opportunity per column 607, and one block for the fourth transmission opportunity per column 609.

If the mobile station assignments and sizes field 520 indicates binary ‘11’ as shown in index column 601, four blocks will be allocated to the mobile station for the first HARQ transmission opportunity as shown in column 603, two blocks for the second HARQ transmission opportunity per column 604, one block for the third HARQ transmission opportunity per column 607, and one block for the fourth transmission opportunity per column 609. The index column 601, may in some embodiments also correspond to a vocoder rate employed for the VoIP communication. For example, “00” may correspond to an ⅛ rate vocoder, “01” to a ¼ rate, “10” to a ½ rate, and “11” to a full rate vocoder, respectively.

Thus, the table 600 may comprise a block allocation for HARQ retransmissions to achieve an expected error criteria. For example, the table 600, given the vocoder rates above was found by simulation of four transmissions for a 1% error where the number of blocks used for each transmission was found by minimizing the average number of time-frequency resources required to achieve the 1% error criteria based on error probabilities after 1 to x blocks, where x was chosen as 16. The block size is indicative of the number of subcarriers used for one timeslot (one slot= 5/9 ms). Each time slot having 5 OFDM total symbols, one being for pilot and control, thus 4 symbols for VoIP transmissions. For example, if the block size for a ⅛ rate frame is 11 subcarriers and one block is used, then 11×4=44 time-frequency resources are available.

Thus in the various embodiments wherein a resource allocation table is used, such as table 600, the continuation field 540 is used to index the table row corresponding to the mobile station assignments and sizes field 520 allocation and wherein the table columns correspond to the particular HARQ transmission opportunity.

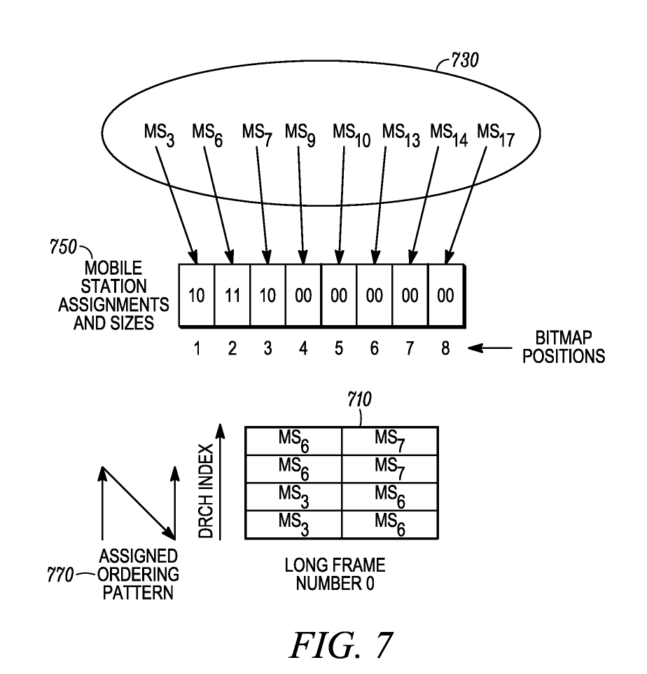

FIG. 7 provides further details of mobile station assignment and resource allocation. In FIG. 7, eight mobile stations are assigned to a group 730 and are assigned group positions 1 through 8, which correspond to bitmap positions 1 through 8 in the mobile station assignments and sizes field 520. Thus, mobile station 3 (MS₃) is assigned bitmap position 1, mobile station 6 (MS₆) is assigned bitmap position 2, mobile station 7 (MS₇) is assigned bitmap position 3, mobile station 9 (MS₉) is assigned bitmap position 4, mobile station 10 (MS₁₀) is assigned bitmap position 5, mobile station 13 (MS₁₃) is assigned bitmap position 6, mobile station 14 (MS₁₄) is assigned bitmap position 7, and mobile station 17 (MS₁₇) is assigned bitmap position 8. Each bitmap position provides two binary bits, where ‘00’ indicates no transmission, ‘01’ indicates an assignment of one block, ‘10’ indicates an assignment of two blocks, and ‘11’ indicates an assignment of four blocks. It is to be understood that the bitmap positions may correspond to one or more bitmap positions in one or more bitmap fields such as, assignments field 510 and allocation sizes field 530, as was discussed previously. Also as discussed previously, it is to be understood that assignments field 510 and allocation sizes field 530 is, for the sake of simplicity of explanation herein, referred to collectively as assignment and sizes field 520.

Returning to FIG. 7, a base station may, in addition to assigning position information, provide to group 730 an indication of the set of shared resources 710 and a assigned ordering pattern 770 indicating the order in which the resources are allocated. The position information, ordering pattern, and shared resource information may be sent by the bases station to the mobile station group 730 using a control channel.

Active mobile stations are also indicated via the mobile station assignments and sizes field 750 via a binary “01,” “10” or “11” in the appropriate bitmap field positions. The mobile station assignments and sizes field 750 may be transmitted on a shared control channel every long frame. As illustrated in FIG. 7, the mobile station assignments and sizes field 750 assigns the Nth active mobile station in each long frame to the Nth set of blocks, where the assigned number of blocks is either 1, 2, or 4 as was discussed above.

Thus for example, MS₃ is assigned the first two resources of resources 710, since it is the first active mobile station, that is, it does not have a “00” (inactive mobile) indicator in the mobile station assignments and sizes field 750. MS₃ is assigned two resources, since “10” is indicated in the mobile station assignments and sizes field 750. MS₆ which does not have a ‘00’ in the mobile station assignments and sizes field 750, that is, the second active mobile station, is assigned the second set of blocks. MS₆ is assigned four blocks, since binary “11” is indicated in the mobile station assignments and sizes field 750.

MS₆ must sum the number of resources previously allocated (the two that were allocated for MS₃) to determine that it is assigned resources three through six as shown in resources 710. MS₇ is the third active mobile station and is assigned the third set of blocks. MS₇ is assigned two blocks in accordance with the binary “10” indication in the mobile station assignments and sizes field 750. MS₇ must sum the number of resources previously allocated, that is, the two resources that were allocated for MS₃ and the four resources that were allocated for MS₆, to determine that it is assigned resources seven and eight as shown in resources 710.

For some applications including voice, packets arrive at a relatively constant rate. For a VoIP application for example, vocoder frames may arrive approximately every 20 ms. Referring again to FIG. 3, for a VoIP application, vocoder frames may arrive approximately every 20 ms beginning at the start of long frame number 0. The base station adds header data to the vocoder frame and encodes the frame to form a voice packet. The base station then modulates and transmits at least a portion of the symbols comprising the voice packet to the mobile station in long frame number 0. This transmission is referred to as the first transmission.

The mobile station receiving the packet will attempt to decode it to obtain the voice information. If the mobile station successfully decodes the voice packet obtained from the first transmission, the mobile station will send an acknowledgement (ACK) message to the base station. Upon receiving an ACK, the base station will not transmit any additional information, that is, will not retransmit, the voice packet to the mobile station in long frames 3, 6, and 9. In fact, the mobile station assignments field, for example assignments field 510, allows these resources to be used by other mobile stations. However, if the mobile station was not able to successfully decode the voice packet, it sends a negative acknowledgement (NACK) message to the base station.

The base station will, upon receiving the NACK message, send additional symbols of the voice packet to the mobile station in long frame number 3. This is referred to as the second transmission. If the mobile station successfully decodes the voice packet after the second transmission, it may send an ACK message to the base station. Upon receiving the ACK message, the base station will refrain from transmitting any additional information to the mobile station in long frames 6 and 9. However, if the mobile station was not able to successfully decode the voice packet, it will send a NACK message to the base station which will, in response, send additional symbols of the voice packet in the third transmission, in long frame number 6.

Similarly the mobile station may send an ACK or NACK message depending upon its successful decoding of the third transmission, and for a NACK message the base station will send additional symbols of the voice packet in the fourth transmission, in long frame number 9. Again the mobile station may send an ACK or NACK message depending upon its success in decoding the packet.

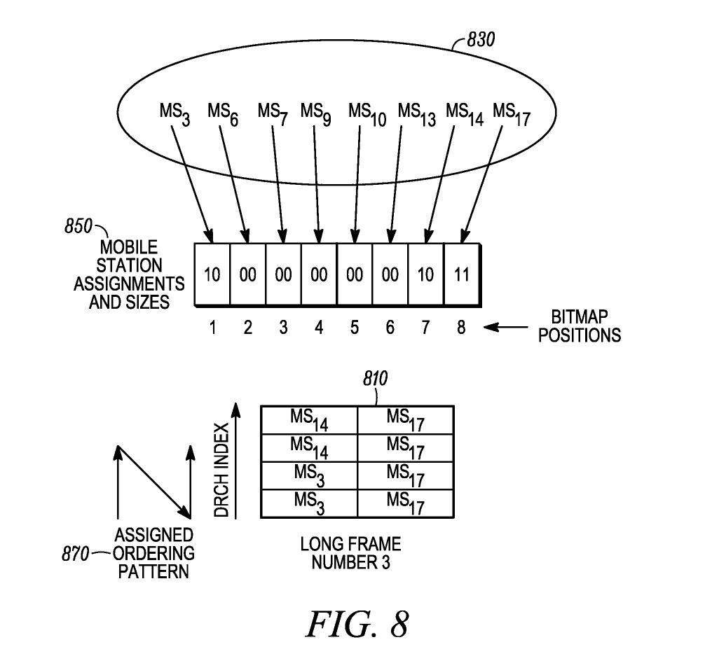

FIG. 8 illustrates a moment in time subsequent to the example shown in FIG. 7, that is, a snapshot of long frame number 3 wherein the scenario depicted in FIG. 7 was a snapshot of long frame number 0. Thus in FIG. 7, after long frame 0, MS₃ may have sent a NACK message while MS₆ and MS₇ may have sent ACK messages. Based on the received ACK and NACK messages and the queue status for each mobile station of group 830, in long frame number 3, the base station may allocate two blocks to MS₃, two blocks to MS₁₄ and four blocks to MS₁₇ using the mobile station assignments and sizes field 850. Based on the mobile station assignments and sizes field 850, the mobile stations of group 830 are assigned the resources 810 as shown.

In a mixed voice and data system, there may be simultaneously active voice and data mobile stations. Due to the statistical multiplexing properties associated with VoIP traffic, there may be system resources unused by the VoIP users at each scheduling instance. For example, if MS₁₇ was not indicated as active, then the fifth, sixth, seventh, and eighth shared resources would be unused. This loading variation can be calculated by any mobile station monitoring the shared control channel. Thus, in some embodiments, the base station may assign a mobile station to those resources that are not used by the group. To determine its assignment during each VoIP frame, the mobile stations monitors the shared control channel and determines its resources as those that have not been allocated to the group members. For the case where a long frame is comprised of multiple frames, different data users can be assigned the unused resources in each frame. Further, more than one mobile station may be assigned to the unused resources. For example, if there are Z unused resources, a first mobile station may be assigned the first N available unused resources, with a second mobile station being assigned the next Z-N unused resources, where Z>=N.

Alternatively, the mobile stations sharing the unused resources may be instructed to equally divide the unused resources. In another alternative method, the mobile station may be instructed to use an offset value from the first available unused resource, where the offset value is used to point that mobile station to its assignment. This allows an arbitrary assignment for each of the mobile stations sharing the unused resources. When there are less unused resources available than required to support a particular mobile station, then the mobile station is not allocated any resources in that long frame. For example, if the offset value points to a shared resource which is beyond the end of the set of shared resources, then that particular mobile station is not allocated any resources in that long frame.

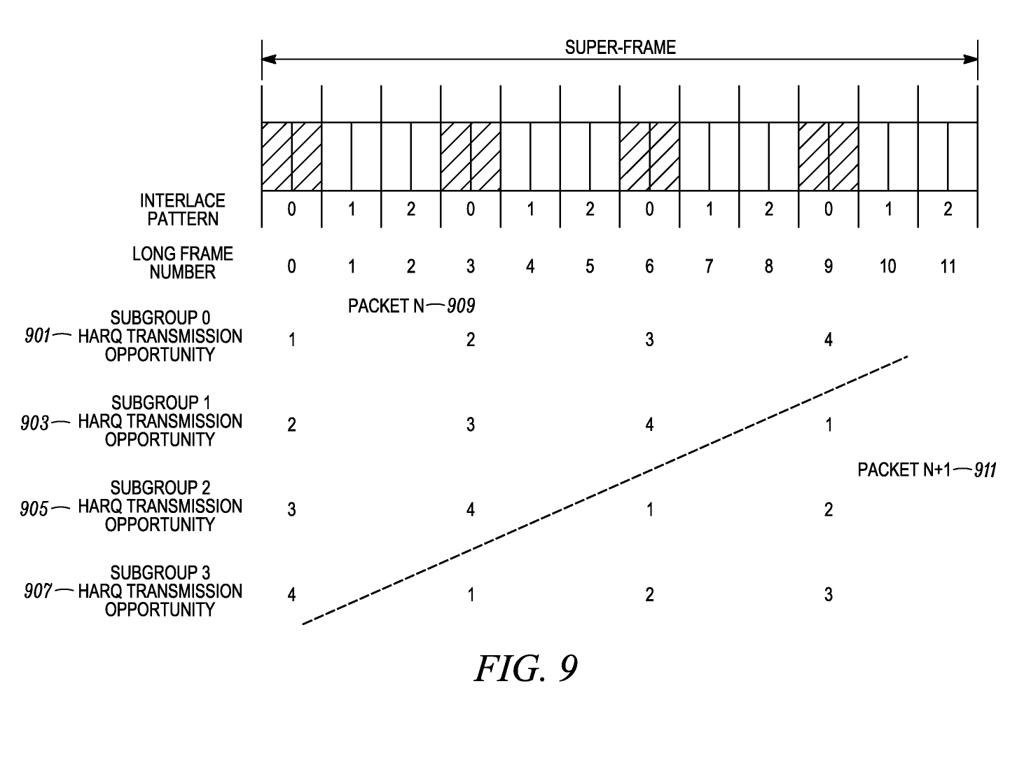

A mobile station assignments and sizes field utilizing two bits per mobile station per long frame as described, may require an undesirable allocation of system resources for the shared control channel, for example power, OFDM subcarriers or OFDM symbols. Thus, in some embodiments, such shared control channel overhead may be reduced by establishing a predetermined relationship between mobile station group position and mobile station HARQ transmission opportunity. FIG. 9 illustrates an example of this predetermined relationship in accordance with various embodiments.

In the embodiments exemplified by FIG. 9, a primary mobile station group is further subdivided into four subgroups, where each subgroup is assigned a particular sequence for its HARQ transmission opportunities. Thus FIG. 9 illustrates two consecutive encoded packets denoted as packet N 909, and packet N+1 911, where N is a positive integer. The base station may thus define the first, second, third, and fourth HARQ transmission opportunities of packet N for subgroup 0 901 to occur in long frame numbers 0, 3, 6, and 9, respectively as shown. Similarly, the base station may define the second, third, and fourth HARQ transmission opportunities of packet N and the first HARQ transmission opportunity of packet N+1 for subgroup 1 903 to occur in long frame numbers 0, 3, 6, and 9 respectively as shown.

This process is repeated as shown in FIG. 9 for subgroups 2 905 and 3 907. The particular sequences of HARQ transmission opportunities repeat at a known interval, for example in each superframe as shown in FIG. 9, for subsequent packets. Based on the established relationships between the subgroups and the HARQ transmission opportunities, the base station may allocate mobile stations to the subgroups in any systematic way as long as it is known by all mobile stations in the group.

For example, for a mobile station group of size “K,” the base station may define the first K/4 group positions to belong to subgroup 0, the second K/4 group positions to belong to subgroup 1, the third K/4 group positions to belong to subgroup 2, and the last K/4 group positions to belong to subgroup 3.

Important to understand is that the predetermined relationship between group position and HARQ transmission opportunity, enables each mobile station in the group to a priori know the HARQ transmission opportunity for all other members of the group. The predetermined relationship may be transmitted from the base station to the mobile stations on a control channel or may be stored at the mobile station, for example in memory.

In some embodiments, resources are allocated to the subgroups in an order corresponding to the defined HARQ transmission opportunity. For example, mobile stations indicated as active in the shared control channel and having their first HARQ transmission opportunity in the current long frame may be allocated first in the set of shared resources. Mobile station indicated as active in the shared control channel and having their second HARQ transmission opportunity in the current long frame may be allocated second in the set of shared resources, etc.

If the subgroups correspond to a contiguous set of group positions, as described above where the first K/4 group positions correspond to subgroup 0, the second K/4 group positions correspond to subgroup 1, etc, then this may be thought of as rotating the bitmap in a circular fashion, such that the first bitmap position corresponds to the first mobile station in the group for which a first HARQ transmission opportunity is defined. An indication of the bitmap rotation may be transmitted from the base station to the mobile station on a control channel or may be stored at the mobile station.

The various embodiments, may also eliminate the need of a High-Speed Shared Control Channel (HS-SCCH) as will now be described in detail. In the various embodiments the HS-SCCH doe not signal a modulation type to the mobile station. Rather, for the various embodiments, the modulation type may be designated to the mobile station by a modulation indicator in the in-band control field, or may be detected “blindly” by the mobile station. Thus, Quadrature Phase Shift Keying (QPSK) modulation with a single Spreading Factor (SF)=16 code may be applied in accordance with one embodiment.

The HS-SCCH of the embodiments does not explicitly signal a channelization code for the mobile station to use for data reception. Rather, a set of channelization codes may be assigned to a group of mobile stations in a semi-static fashion such that when the mobile station is scheduled, the mobile station may receive data on one code that belongs to this set of pre-allocated codes.

Further, in the various embodiments, one transport block size indicating the VoIP packet size for a given Vocoder rate of the user, is semi-statically assigned at call setup by higher-layer signaling. A single HARQ process in employed, and preconfigured by higher layers, as no HARQ process ID is provided by the various embodiments. Thus, an implicit redundancy version (RV) may be applied for retransmissions and the maximum number of retransmissions is set to one.

It is to be understood that while the embodiments described herein are based on voice applications such as VoIP, the various embodiments are not so limited and are applicable, in general, to any application utilizing similarly constrained packets sizes, as is the case for a given vocoder in a VoIP application, and thus various embodiments will be apparent for other such applications such as, but not limited to, gaming applications wherein a packet size may be determined.

Regarding HARQ feedback signaling ACK/NACK is used for only the first transmission. Thus, in the various embodiments a VoIP call may be provided with semi-static information as discussed above, the semi-static information comprising; assignment of mobile stations to groups, assignment of the set of channelization codes to each group (allocated during call setup), implicit redundancy version signalling, and the single HARQ process. Therefore, in the various embodiments bits need not be transferred for HARQ process identity, group membership assignment, and channelization code set indications.

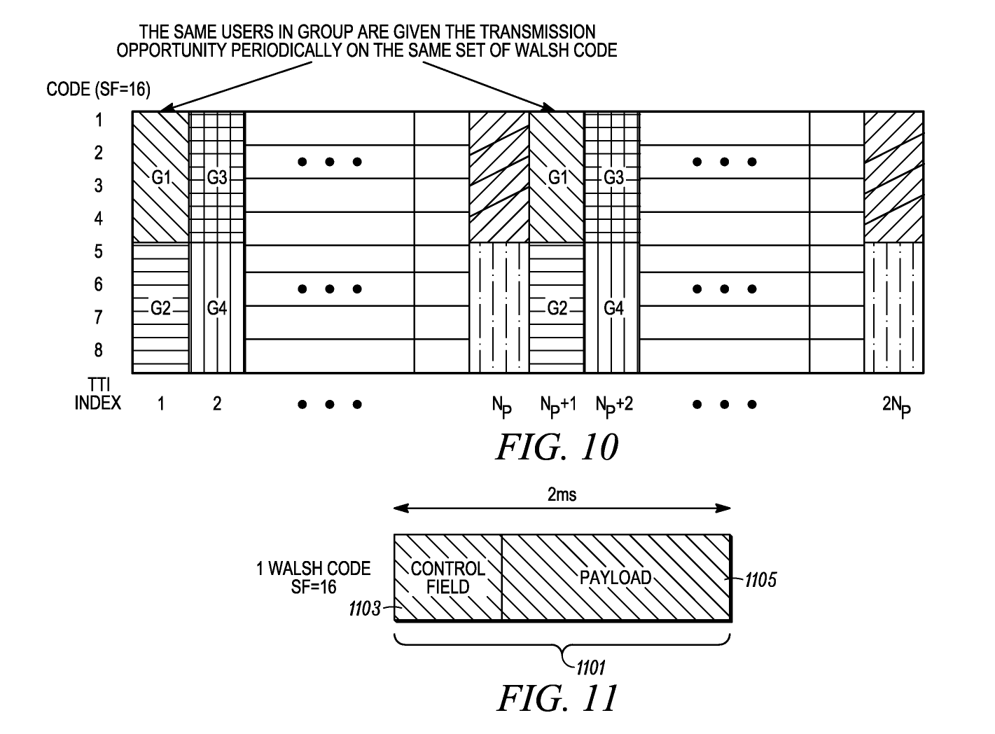

FIG. 10 illustrates further details of the various embodiments with respect to grouping and periodic resource allocation. In FIG. 10, a two-dimensional time-code resource map is illustrated and shown divided into Np×Ng periodic transmission slots for Groups G1 through G4, where Np is the number of Transmission Time Intervals (TTIs) that indicate the intermittent transmission opportunity for each group, intermittent including periodic and a-periodic, and Ng is the maximum number of groups served at a given TTI. Each transmission slot is assigned to one of the groups. Any transmission slot may be used to transmit new data or HARQ retransmissions.

Each group may be allocated up to Nc channelization codes with spreading factor (SF)=16. The assignment of mobile stations to a group is accomplished in a semi-static manner as was discussed above, with the number of mobile stations per group varying based on various criteria, such as, but not limited to system loading.

Thus for example with respect to FIG. 10, if Np=6 and Ng=2, with 12 total groups, and assuming each group is assigned ten VoIP mobile stations then the nominal number of VoIP users supported is (Ng×Np×total groups)=(2×6×10)=120 VoIP users. In the case of this example, Nc=4 codes are assigned to each group, and a total of 8 codes are utilized every TTI.

In the various embodiments, if a mobile station is scheduled to transmit at a given TTI, the mobile station's payload packets will be carried using a single Orthogonal Variable Spreading Factor (OVSF) code. Thus, with respect to the example, if Nc=4 codes are assigned to a group, then at most 4 out of 10 mobile stations will be scheduled at a given TTI.

Further in some embodiments, frame bundling may be employed to take advantage of the small packet sizes of VoIP traffic. Thus, several VoIP packets of a given mobile station may be aggregated and transmitted using a single SF 16 channelization code. Thus in the various embodiments, Narrowband Adaptive Multi-rate (NB-AMR) codecs and Wideband Adaptive Multi-rate (WB-AMR) codecs may be supported using frame bundling by increasing the number of aggregated packets for NB-AMR and decreasing the number for WB-AMR, for example.

However, frame bundling is limited to packets belonging to a single mobile station, and multi-user frame bundling (i.e. where a single data payload is comprised of component packets addressed to more than one mobile station) is not used in the various embodiments to simplify HARQ design. In the various embodiments, up to three frames may be bundled for the same mobile station.

FIG. 11 illustrates a control signal, such as an HS-SCCH control signal, using in-band control signaling having separate encoding for control and data fields in accordance with various embodiments. In FIG. 11, a single OVSF code is assigned to a scheduled mobile station in a given TTI. Note that constant transmission power is assumed throughout the 2 ms TTI. Thus, FIG. 11 represents a single resource 1101 of SF=16, thus a single Walsh Code having a control field 1103 and a payload 1105.

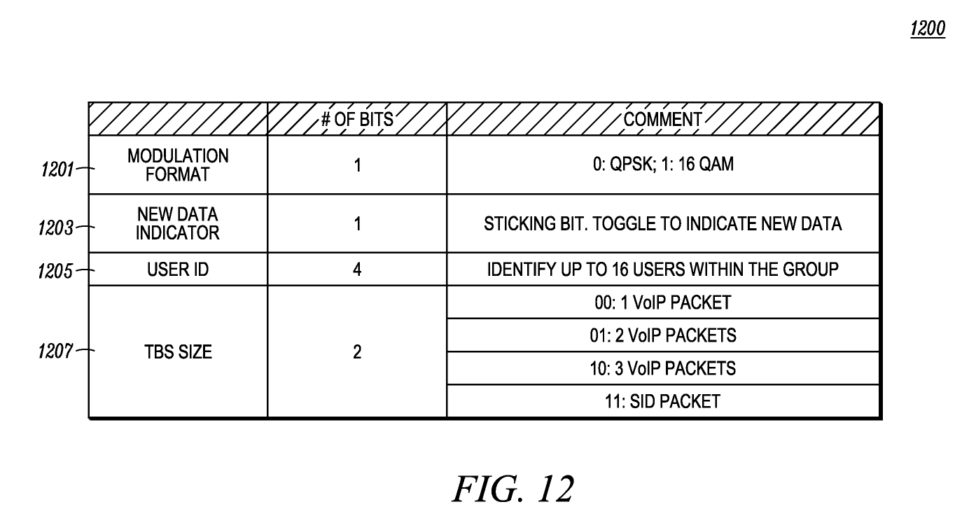

FIG. 12 is a table 1200 providing exemplary information contained in the control field 1103 of resource 1101. The control field may or may not employ Cyclic Redundancy Check (CRC) and remain in accordance with the various embodiments herein disclosed. However, in some embodiments the payload 1105 will utilize a 24-bit CRC masked by a mobile station identification information.

However, it is preferable that the control field 1103 be coded such that its performance is at least better than the best performing low-code-rate payload in terms of Frame Erasure Rate (FER). This helps to ensure that control signaling has a high likelihood of error-free reception if the payload is error free.

Returning to FIG. 12, a Transport Block Size (TBS size) 1207 is used to indicate 1, 2, or 3 VoIP packets or a Silence Descriptor (SID) packet. Other applicable voice and video codecs use different rate control and discontinuous transmission techniques, which may lead to different VoIP packet dimensions, data rates, or means of encoding voice. In the various embodiments it is implicitly assumed that knowledge of the dimensions of the VoIP packet selected for each AMR vocoder rate, and therefore the VoIP packet size, is semi-statically determined for each mobile station and conveyed to each mobile station via, for example, higher-layer signaling. Thus, the two-layer structure of signaling the TBS size 1207 provides support for per-mobile station AMR code rate reconfigurations and frame bundling for VoIP capacity improvement.

Data, that is, payload 1105, may be transmitted using either QPSK or 16-QAM (Quadrature Amplitude Modulation). The control information may be transmitted using QPSK, which would result in discontinuous modulation format within a code of a TTI, or 16-QAM and using blind detection to obtain the modulation format. In this case, the modulation format 1201 bit is not needed in the control field 1103.

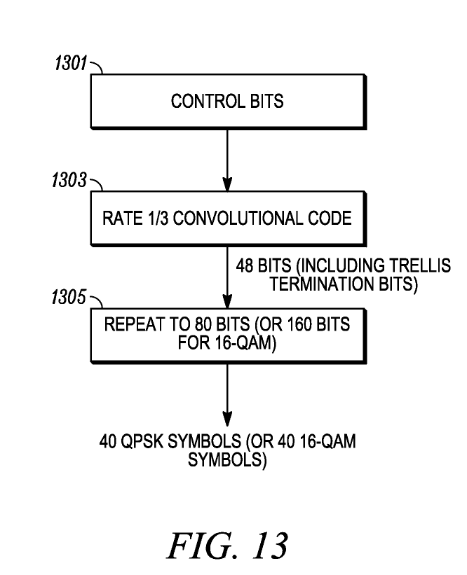

FIG. 13 illustrates an error-correction coding scheme for the control field 1103 in accordance with some embodiments. Thus, 8 control information bits 1301 in the control field 1103 are mapped to 40 symbols at the beginning of a 2 ms TTI.

For the various embodiments, systematic redundancy versions (RV) for HARQ are employed. Further, the component codewords (i.e. the specific redundancy versions to be transmitted in each H-ARQ transmission or re-transmission instance) from the parent codeword may be generated implicitly by an index associated the H-ARQ transmission. Such an index may comprise, for example, the number, in sequence, of the particular H-ARQ transmission or re-transmission bearing the redundancy version in the sequence of redundancy versions. Alternatively, the transmission index may be a system frame or super-frame index, or some other network timing parameter. Further, ACK/NACK is used by a mobile station only for the first transmission. All scheduled mobile stations in a group will transmit ACK or NACK as appropriate, in the uplink in a synchronous manner. Separate buffer space may be allocated for the HARQ process and may be part of the total available soft memory locations.

In a further embodiment, the mobile station may apply various hypotheses when receiving the control and data codewords transmitted by the base station. For example, if the mobile station receives what it believes to be a first codeword transmission (of both data and control), and either the CRC associated with the control field (or codeword) or the CRC associated with the data field (or codeword) fail, the mobile may hypothesize the transmission of a related redundancy version in a prior transmission occasion in accordance with the group timeslot structure previously discussed. The mobile station may then combine the observations (e.g. log-likelihood ratios, or other soft decision information) of the current and hypothesized prior observations of the codewords. The combining procedure may be based on Chase combining, codeword reconstruction by incremental redundancy version augmentation, or other techniques well known in the art. The mobile then attempts to re-decode the data field under the hypothesis of prior transmission.

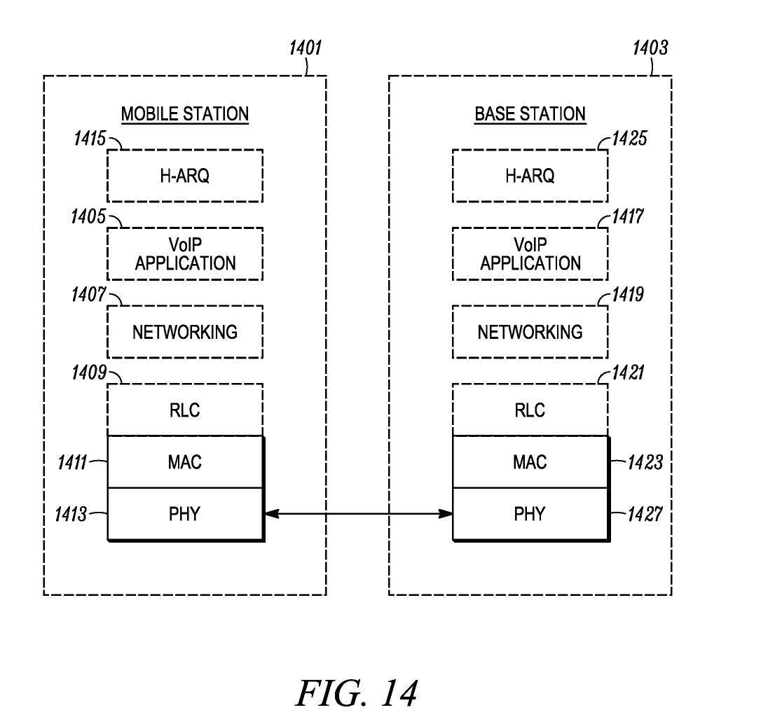

Turning now to FIG. 14, a mobile station 1401 and base station 1403 architectures in accordance with the various embodiments are illustrated. Mobile station 1401 comprises a stack having a VoIP application 1405, a networking layer 1407, a Radio Link Controller (RLC) 1409, a Medium Access Controller (MAC) 1411, and a Physical Layer (PHY) 1413. In addition, mobile station 1401 has HARQ component 1415, which may be separate or may be integrated into any of the other components/layers. As described in detail above, the mobile station 1401 VoIP application 1405 may utilize a single Walsh or OVSF code of PHY 1413 layer to receive a data payload field 1105 and a control field 1103 having various modulations as described above.

The base station 1403 similarly has a VoIP application 1417, a networking layer 1419, a RLC 1421, MAC 1423 and PHY 1427. However, base station 1403 additionally has in the various embodiments HARQ scheduling component 1425. As described in detail above, the base station 1403 HARQ scheduling component 1425 may send a continuation field and/or a resource allocation table to groups and/or subgroups of mobile stations for indicating their resource allocations for receiving subsequent HARQ block retransmissions. Further, the HARQ scheduling component 1425 may define the HARQ subgroups in some embodiments. In the various embodiments only a single HARQ retransmission will be sent by H-ARQ component 1425 as was described above.

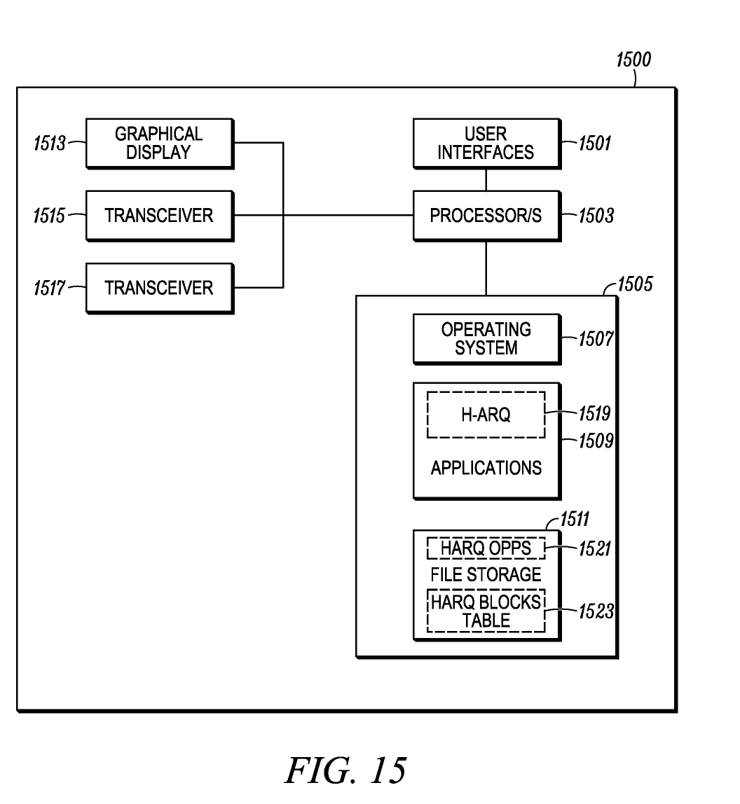

FIG. 15 is a block diagram illustrating the primary components of a mobile station in accordance with some embodiments. Mobile station 1500 comprises user interfaces 1501, at least one processor 1503, and at least one memory 1505. Memory 1505 has storage sufficient for the mobile station operating system 1507, applications 1509 and general file storage 1509. Mobile station 1500 user interfaces 1501, may be a combination of user interfaces including but not limited to a keypad, touch screen, voice activated command input, and gyroscopic cursor controls. Mobile station 1500 has a graphical display 1513, which may also have a dedicated processor and/or memory, drivers etc. which are not shown in FIG. 15.

It is to be understood that FIG. 15 is for illustrative purposes only and is for illustrating the main components of a mobile station in accordance with the present disclosure, and is not intended to be a complete schematic diagram of the various components and connections therebetween required for a mobile station. Therefore, a mobile station may comprise various other components not shown in FIG. 15 and still be within the scope of the present disclosure.

Returning to FIG. 15, the mobile station 1500 may also comprise a number of transceivers such as transceivers 1515 and 1517. Transceivers 1515 and 1517 may be for communicating with various wireless networks using various standards such as, but not limited to, UMTS, E-UMTS, E-HRPD, CDMA2000, 802.11, 802.16, etc.

Memory 1505 is for illustrative purposes only and may be configured in a variety of ways and still remain within the scope of the present disclosure. For example, memory 1505 may be comprised of several elements each coupled to the processor 1503. Further, separate processors and memory elements may be dedicated to specific tasks such as rendering graphical images upon a graphical display. In any case, the memory 1505 will have at least the functions of providing storage for an operating system 1507, applications 1509 and general file storage 1511 for mobile station 1500. In some embodiments, and as shown in FIG. 14, applications 1509 may comprise a software stack that communicates with a stack in the base station. Therefore, applications 1509 may comprise HARQ component 1519 for providing the capabilities of using the HARQ scheduling information received from a base station as was described in detail above. File storage 1511 may provide storage for an HARQ OPPS allocation, as illustrated by FIG. 9, and an HARQ Blocks table, such as table 600 illustrated by FIG. 6.

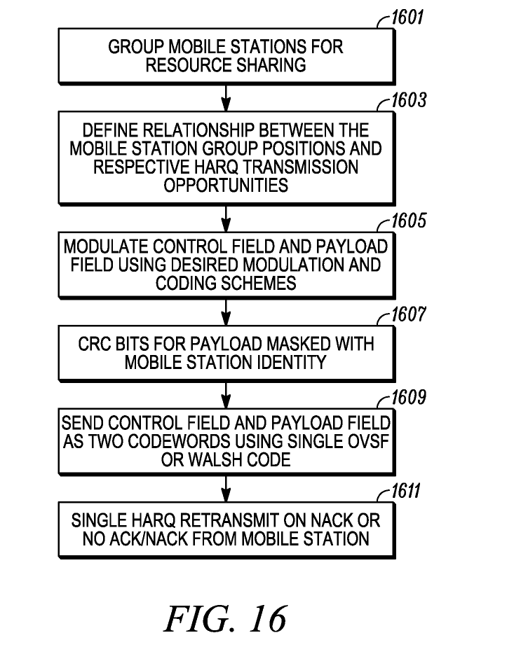

FIG. 16 summarizes operation of a base station in accordance with the various embodiments. In 1601, the base station groups mobile stations for scheduling resources based on various criteria as was discussed previously. In 1603, the base station may define a relationship between the mobile station's group positions and their respective HARQ transmission opportunities as was described with respect to FIG. 9. In 1605, the base station modulate a control field and a payload field using different or identical modulation and coding schemes as was discussed in detail above. In 1607, the base station may determine a CRC bit sequence applicable to the payload field using the mobile station identity associated with the voice packets of the payload field. In 1609, the base station may send the control field and the data field using a single OVSF or a single Walsh code. In 1611 the base station may retransmit a single retransmission if a NACK message is received from a mobile station, or if the mobile station does not transmit an ACK/NACK following the first transmission (no ACK/NACK), which indicates the mobile does not detect a VoIP packet due to error in the decoding of the control fields.

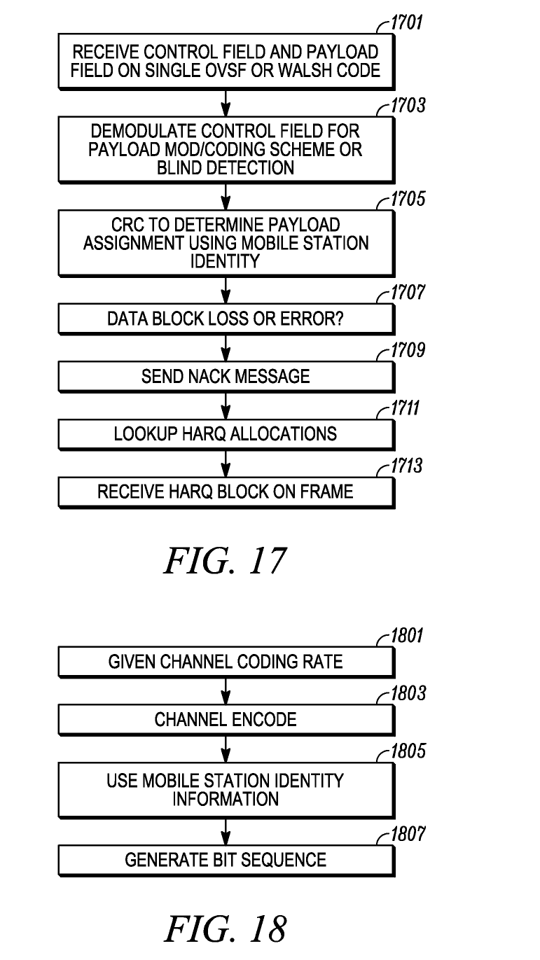

FIG. 17 is a flow chart showing operation of a mobile station. In 1701 the mobile station receives a control field and payload field on a single OVSF or Walsh code and demodulates both as shown in 1703. As was discussed in detail above, blind detection may be used in some embodiments. In 1705, the mobile station may determine whether it has received data by using the CRC comprising mobile station identity information. In 1707, if a data loss or error occurs the mobile station will send a NACK as in 1709. The mobile station may then lookup its HARQ allocation as in 1711, or use any other appropriate approach, and receive an HARQ retransmission as shown in 1713.

FIG. 18 illustrates further details of a base station generation of CRC bit sequences for a payload field in accordance with some embodiments. Thus, given a channel coding rate in 1801, the base station encodes the data payload in 1803 and uses a mobile station identity information as shown in 1805, to generate the CRC bit sequence for the payload field as shown in 1807.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a base station, the method comprising:
assigning a set of mobile stations to a group, wherein each mobile station is assigned an identity in the group;
assigning said group a first set of shared resources;
associating each said group with an automatic repeat request system retransmission opportunity;
sending a first codeword and a second codeword via one of said set of shared resources, said first codeword containing control message information and said second codeword containing an information packet; and
sending a encoded bit sequence, associated with said information packet, comprising an identity information associated with a specific mobile station of said group.

2. The method of claim 1, wherein assigning said group a first set of shared resources further comprises: assigning a set of contiguous channelization codes or assigning a set of non-contiguous channelization codes.

3. The method of claim 1, wherein sending a first codeword and a second codeword via one of said set of shared resources, further includes sending said first codeword and said second codeword using a single channelization code.

4. The method of claim 1, further comprising:
sending a second instance of said second codeword wherein said second codeword comprises a first code sub-word and said second instance of said second codeword comprises a second code sub-word, said first code sub-word and said second code sub-word derived from a parent codeword and wherein selection of said first and second code sub-words are specified by a transmission index.

5. The method of claim 1, further comprising:
sending a higher layer signaling message restricting the length of said information packet to one of a set of specified packet lengths.

6. The method of claim 1, further comprising:
sending a higher layer signaling message restricting the length of said information packet to one of a set of specified packet lengths wherein said specified packet lengths correspond to aggregated numbers of vocoder packets.

7. The method of claim 1, further comprising:
modulating said first codeword using a first modulation and coding scheme and modulating said second codeword using a second modulation and coding scheme different from said first modulation and coding scheme.

8. The method of claim 1, further comprising:
sending a second instance of said first codeword further comprising an indicator for a second instance of said control message information, and a second codeword containing said second instance of said information packet.

9. A mobile station comprising:
at least one transceiver;
at least one processor coupled to said transceiver; said processor and said transceiver configured to:
determine an allocated resource, from a first set of shared resources;
receive a first codeword and a second codeword via said allocated resource, said first codeword containing control message information and said second codeword containing an information packet; and
receive an encoded bit sequence, associated with said information packet, comprising an identity information associated with said mobile station.

10. The mobile station of claim 9, wherein said processor and said transceiver are further configured to demodulate said first codeword using a first modulation and coding scheme and demodulate said second codeword using a second modulation and coding scheme different from said first modulation and coding scheme.

11. The mobile station of claim 9, wherein said processor and said transceiver are further configured to receive a second instance of said first codeword further comprising an indicator for said second instance of said one information packet, and a second codeword containing said second instance of said information packet.

12. The method of claim 9, wherein said processor and said transceiver are further configured to monitor a shared control channel controlling resource allocation of a second set of shared resources.

13. The method of claim 12, wherein said processor and said transceiver are further configured to determine allocated information from said shared control channel using a second identity information different from said identity information wherein said identity information is further associated with a group assigned to said mobile station.

14. The method of claim 9, wherein said processor and said transceiver are further configured to:
attempt decoding of a current observation of said first codeword and said second codeword, wherein if said decoding fails, hypothesize a prior transmission of said first codeword and said second codeword, and combine said current observation of said first codeword and said second codeword with a hypothesized prior observation of said first codeword and said second codeword before decoding said first codeword and second codeword

15. The mobile station of claim 9, wherein said processor and said transceiver are further configured to receive an encoded bit sequence wherein said bit sequence in obtained by using a channel coding rate associated with said information packet, and said identity information.

16. The mobile station of claim 9, wherein said allocated resource is a radio resource channel having an orthogonal variable spreading factor code.

17. A base station comprising:
a transceiver;
a processor coupled to said transceiver, said transceiver and said processor configured to:
assign a mobile station to a group, wherein said mobile station is assigned an identity in said group;
assign said group a first set of shared resources wherein said shared resources are intermittently available resources;
associate each said group with an automatic repeat request system retransmission opportunity;
send a first codeword and a second codeword via one of said first set of shared resources, said first codeword containing control message information and said second codeword containing an information packet; and
send an encoded bit sequence, associated with said information packet, comprising an identity information associated with said mobile station.

18. The base station of claim 17, wherein said transceiver and said processor are further configured to:
modulate said first codeword using a first modulation and coding scheme and modulate said second codeword using a second modulation and coding scheme different from said first modulation and coding scheme.

19. The base station of claim 17, wherein said transceiver and said processor are further configured to:
send a second instance of said at least one information packet by sending a second instance of said first codeword further comprising an indicator for said second instance of said information packet, and a second codeword containing said second instance of said information packet.

20. The base station of claim 17, wherein said transceiver and said processor are further configured to:
obtain said cyclic redundancy bit sequence by using a channel coding rate associated with said at least one voice information packet, and said identity information.

21. The base station of claim 17, wherein said transceiver and said processor are further configured to send a first codeword and a second codeword via one of said first set of shared resources by sending said first codeword and said second codeword using a single channelization code.
